(19) United States
(12) Patent Application Publication
(10) Pub. No.: US 2023/0078232 A1
(43) Pub. Date: Mar. 16, 2023

(54) OIL SOLENOID VALVE WITH REAL TIME MONITORING OF PLUNGER POSITION

(71) Applicant: PADMINI VNA MECHATRONICS PVT. LTD., GURGAON (IN)

(72) Inventors: KABIR BHANDARI, GURGAON (IN); AMARDIP KUMAR, GURGAON (IN); KUMAR ABHISHEK, GURGAON (IN); SUDHIR PATTNAIK, GURGAON (IN)

(21) Appl. No.: 17/904,154

(22) PCT Filed: Feb. 15, 2021
(86) PCT No.: PCT/IB2021/051262

§ 371 Date: Aug. 12, 2022

(30) Foreign Application Priority Data
Feb. 13, 2020 (IN) 202011006315

(51) Int. Cl. F16K 31/06; F16K 27/02; F16K 31/08; F16K 37/00; G01D 5/14

(52) U.S. Cl. CPC F16K 31/0655; F16K 27/029; F16K 31/082; F16K 37/0041; G01D 5/145

(57) ABSTRACT

The present invention provides a system to detect real time plunger position in oil solenoid valve. More particularly, the present invention provides a position sensor embedded in the oil solenoid valve for detecting a plunger position in real time by downward movement of the plunger and having application in automobile for cooling of turbocharger.

### FIELD OF THE INVENTION

The present invention provides a system to detect real time plunger position in oil solenoid valve. More particularly, the present invention provides a position sensor embedded in the oil solenoid valve for detecting a plunger position in real time by downward movement of the plunger and having application in automobile for cooling of turbocharger.

### BACKGROUND OF THE INVENTION

A solenoid device is an electromechanical control unit which shuts or allows the fluid flow, when electrically energized or de-energized. It consists of several parts such as but not limited to solenoid coil, bobbin, moving core, core tube, valve body etc. The magnetic coil of the solenoid is arranged radially relative to the axis of the magnet because the flux of the permanent magnet also extends radially relative to the operating axis of the valve plug and through the armature. There are several areas where solenoid valve is useful such as in pneumatic and hydraulic systems to control cylinders or larger industrial valves, automatic irrigation sprinkler systems also use solenoid valves with an automatic controller.

Many solenoid valves of this type do not provide a means for determining the actual condition of the actuator. In other words, when an electric current is provided to the coil of the solenoid to move the plunger toward one position or the other, no means is readily available to determine if the plunger actually responded to the magnetic field. In solenoid valve which are configured to provide a reciprocating capability, wherein an actuation of the solenoid causes the plunger to move into a first and in a second position after the solenoid coil is deactivated, it is particularly important to be able to determine the actual position of the plunger. The means for determining the actual position of the plunger is important because several malfunctions can possibly cause the plunger to be in a position other than that which is intended. For example, the solenoid coil may not actually have been actuated by the anticipated flow of current through its conductor. This could be caused by a broken wire or a disconnection in the electrical circuit of the solenoid. Even if the solenoid operates properly and the plunger moves in the intended direction, a subsequent shock to the apparatus could possibly cause harm to any of the integral part which leads to un-proper functioning of system.

In present era, various system and methods are developed to detect the plunger position of the solenoid valve, but does not exist any system or method for real time monitoring of plunger position in oil solenoid valve.

Therefore, there is a need of develop a reliable system that provides real time monitoring of a plunger position in an oil solenoid valve by programming the position sensor at different gauss values obtained during downward motion of plunger.

### OBJECT OF THE INVENTION

The main object of the present invention is to provide an oil solenoid valve incorporated with at least one permanent magnet for providing feedback of plunger position.

Another object of the present invention is to provide a system to monitor plunger travel in an oil solenoid valve through an I.C. incorporated with a permanent magnet.

Yet another object of the present invention is to develop a system that provides automatic regulation of plunger position in an energized state by measuring the gauss values of permanent magnet at downward motion of plunger in an oil solenoid valve.

### SUMMARY OF THE INVENTION

The present invention provides a system for real time monitoring of plunger position in oil solenoid valve. More particularly, the present invention provides an oil solenoid valve having a hall sensor with I.C. (integrated circuit) to measure the plunger position according to the different gauss values obtained by the downward motion of permanent magnet fused plunger.

In an embodiment of the present invention, an oil solenoid valve with real time monitoring of plunger position comprises of a valve body, a permanent magnet, a hall sensor based I.C, a moving core, a guide pin, a plunger, a bobbin, a bush, at least one spring, an inlet port, an outlet port and a fixed sleeve; wherein, the plunger preferably a brass plunger is movable and is connected with moving core through guide pin; the guide pin is movable part and is interlinked between moving core and plunger; and the moving core is interlinked between the permanent magnet and plunger through guide pin. The moving core start moving in downward direction along with the plunger through the guide pin during the energization of solenoid valve. The hall sensor based I.C measures the position of plunger by sensing the different gauss values corresponding to the downward motion of permanent magnet associated plunger and generates output feedback in a digital or analog form.

### BRIEF DESCRIPTION OF THE DRAWING

A complete understanding of the system and method of the present invention may be obtained by reference to the following drawings:

FIG. 1 illustrates a schematic diagram of oil solenoid valve in energizing condition of solenoid valve in accordance to an embodiment of the present invention.

FIG. 2 illustrates a schematic diagram of oil solenoid valve in de-energizing condition of solenoid valve in accordance to an embodiment of the present invention.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a real time monitoring of plunger position in an oil solenoid valve by employing a hall sensor based integrated circuit (I.C). More particularly, the plunger position is monitored continuously by programming the sensor at multiple point of gauss values corresponding to the downward motion of the plunger.

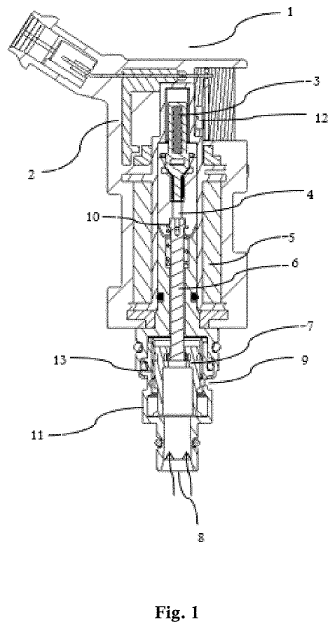

In a main embodiment, referring to FIG. 1, sectional view of oil solenoid valve (1) in energized condition as per the present invention is shown. Said oil solenoid valve (1) comprises a valve body (2) having hollow axial space for housing entire valve assembly; a moving core (4) and a plunger (7) is assembled inside the inner diameter of a bobbin (5); a guide pin (6) is movable part that is interlinked between moving core (4) and plunger (7); a permanent magnet (3) is mounted on the moving core (4); an inlet port (8) is provided on the bottom and an outlet port (9) is provided on radial surface of the fixed sleeve (11) and a hall sensor with I.C (12) is fixed inside the valve body (2). A bush (13) is provided between the fixed sleeve (11) and plunger (7).

The fixed sleeve (11) is attached on the bottom of the valve body (2) and is made of material including but not limited to metal, plastic or alike The plunger (7) is connected with guide pin (6) on the top and supported with a compression spring (10) at the mid. When solenoid valve is energized, the moving core (4) moves downward along with permanent magnet (3) against the spring (10), as the permanent magnet (3) changes its position it generates different gauss values at different positions. Further, the hall sensor with I.C (12) encoded with different gauss values detect the position of plunger (7) and generates the output in the digital or analog form and feedback the detected plunger position to the engine control unit in order to turn on or off the pump. The plunger (7) is made of material such as but not limited to brass, copper, steel, plastic or alike and the moving core (4) is made of material such as but not limited to plastic, non-metals or alike.

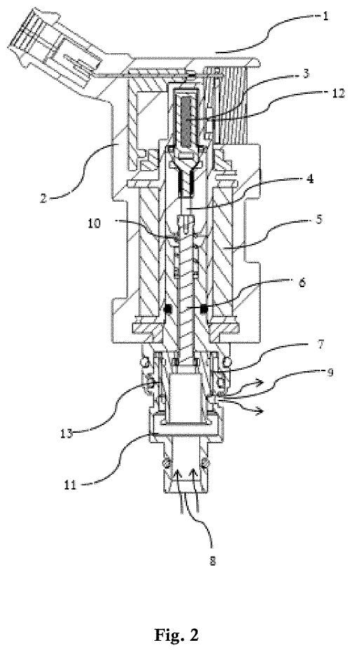

Now referring to FIG. 2 shows sectional view of oil solenoid valve (1) in de-energized condition as per the present invention. When oil solenoid valve (1) is de-energized, the spring (10) restore to its original position which moves the plunger (7) in upward direction. The guide pin (4) also moves in the upward direction as it is associated with the plunger (7), this changes the position of permanent magnet (3). Further, changes in permanent magnet (3) produces different gauss values, and the hall sensor with I.C (12) encoded with different gauss values detect the position of plunger position in real time.

The present invention provides a real time measurement of plunger position to ensure the end positions during on and off condition and provide feedback to engine control unit. During the energizing condition of solenoid valve, the moving core start moving in downward position with the plunger. The permanent magnet also moves downward since it is incorporated with the moving core. The movement of plunger along with the magnet and moving core through the guide pin generates the gauss value. The generated gauss value is different at different position of plunger i.e. 0.1 mm incremental plunger travel produces the different gauss value at each point.

The hall sensor with I.C senses the generated gauss value and detects the position of plunger. The detected position of the plunger is continuously monitored and feedback to the automobile engine control unit in a form of digital or analog to automatically turn on or off the pump accordingly.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. An oil solenoid valve (1) with real time monitoring of plunger position comprising:
a valve body (2); a permanent magnet (3), a hall sensor based integrated chip (I.C.) (12), a moving core (4), a guide pin (6), a plunger (7), a bobbin (5), a bush (13), at least one spring (10), an inlet port (8), an outlet port (9) and a fixed sleeve (11);
wherein,
said plunger (7) is movable and connected with said moving core (4) through said guide pin (6);
said moving core (4) is interlinked between the permanent magnet (3) and the plunger (7) through the guide pin (6);
said moving core (4) moves downward with plunger (7) when said oil solenoid valve (1) is energized; and
said hall sensor based I.C. (12) measures position of plunger (7) by sensing gauss valve corresponding to motion of the permanent magnet (3) associated with plunger (7) and generates an output in digital or analog form.

2. The oil solenoid valve (1) as claimed in claim 1, wherein said plunger (7) is made of a material including but not limited to brass, copper, steel, plastic or alike.

3. The oil solenoid valve (1) as claimed in claim 1, wherein the inlet port (8) is provided on bottom and the outlet port (9) is provided on radial surface of the fixed sleeve (11).

4. The oil solenoid valve (1) as claimed in claim 1, wherein the bush (13) is provided between the fixed sleeve (11) and the plunger (7).

5. The oil solenoid valve (1) as claimed in claim 1, wherein the fixed sleeve (11) is made of a material including but not limited to metal, plastic or alike.

6. The oil solenoid valve (1) as claimed in claim 1, wherein the moving core (4) is made of material such as but not limited to plastic, non-metals or alike.

7. The oil solenoid valve (1) as claimed in claim 1, wherein said output generated is sent to an engine control unit.

8. The oil solenoid valve (1) as claimed in claim 1, wherein said gauss value is different at different position of plunger (7).
